(19) United States
(12) Patent Application Publication
(10) Pub. No.: US 2015/0162620 A1
(43) Pub. Date: Jun. 11, 2015

(54) AIR BATTERY AND AIR ELECTRODE THEREOF

(71) Applicant: Industrial Technology Research Institute, Hsinchu (TW)

(72) Inventors: Yi-Cheng LEE, Zhudong Township (TW); Wen-Sheng CHANG, Pingtung City (TW); Ming-Hsiu LU, Xinpu Township (TW); Chang-Chung YANG, Taipei City (TW)

(73) Assignee: Industrial Technology Research Institute, Hsinchu (TW)

(21) Appl. No.: 14/144,040

(22) Filed: Dec. 30, 2013

(30) Foreign Application Priority Data
Dec. 6, 2013 (TW) 102144916

(51) Int. Cl. H01M 4/90; H01M 12/08

(52) U.S. Cl. CPC H01M 4/9016; H01M 4/9075; H01M 12/08

(57) ABSTRACT

The disclosure provides an air battery which includes a metallic electrode, an air electrode, a battery box and an electrolyte. The metallic electrode, the air electrode and the electrolyte are disposed in the battery box. The air electrode includes a current collector and a catalytic layer. The composition of the current collector contains nickel, chromium and iron. The catalytic layer is loaded on the current collector. The material of the catalytic layer contains α-MnO₂.

### CROSS-REFERENCE TO RELATED APPLICATIONS

This non-provisional application claims priority under 35 U.S.C. §119(a) on Patent Application No(s). 102144916 filed in Taiwan, R.O.C. on 6 Dec., 2013, the entire contents of which are hereby incorporated by reference.

### TECHNICAL FIELD

The disclosure relates to an air battery and an air electrode thereof.

### BACKGROUND

Accompanied with the development of global economics and the increase of the world's population, the consumption of energy has been greatly increased. Therefore, alternative energy has become more and more important. Recently, a method for storing energy by fuel cells or air batteries, which directly transform the chemical energy into electrical energy and have environmental friendly products, have been highly expected to be a better energy storage device.

As for the air batteries, the air batteries produce hydroxide ions and metallic oxide when discharging. The products are reusable, safer, more stable and more convenient than other conventional methods.

When the air batteries discharge, the metallic electrodes (zinc) of the air batteries are oxidized, so that electrons enter the air electrodes (cathodes) through the external circuits. Also, the air electrodes undergo the oxygen reduction reaction (ORR) so as to reduce oxygen. As for the secondary air batteries, which are rechargeable (i.e. charging and discharging repeatedly), the air batteries need certain designs for the charging process. Furthermore, the air electrodes undergo the oxygen evolution reaction (OER) and reproduce oxygen when the air batteries are charged.

However, both the oxygen reduction reaction and the oxygen evolution reaction need catalysts for accelerating the reactions. Therefore, it is important to select/fabricate appropriate ORR/OER catalysts to enhance the efficiency of air batteries.

### SUMMARY

According to an embodiment of the disclosure, an air electrode is provided. The air electrode comprises a current collector and a catalytic layer. The composition of the current collector contains nickel, chromium and iron The catalytic layer is loaded on the current collector. The material of the catalytic layer contains α-MnO₂.

According to an embodiment of the disclosure, an air battery is provided. The air battery comprises a metallic electrode, an air electrode a battery box and an electrolyte. The air electrode comprises a current collector and a catalytic layer. The composition of the current collector contains nickel, chromium and iron. The catalytic layer is loaded on the current collector. The material of the catalytic layer contains α-MnO₂. The metallic electrode, the air electrode and the electrolyte are disposed in the battery box.

### BRIEF DESCRIPTION OF THE DRAWINGS

The present disclosure will become more fully understood from the detailed description given hereinbelow, along with the accompanying drawings which are for illustration only, thus are not limitative of the present disclosure, and wherein:

FIG. 1A is a schematic cross-sectional view of an air battery according to an embodiment of the disclosure;

FIG. 1B is a schematic cross-sectional view of an air battery according to another embodiment of the disclosure;

FIG. 2 is a schematic cross-sectional view of an air electrode according to an embodiment of the disclosure;

FIG. 3A is a diagram of a relationship between voltage and time when the air battery of embodiment 1 charges/discharges;

FIG. 3B is another diagram of a relationship between voltage and time when the air battery of embodiment 1 charges/discharges;

FIG. 4 is a diagram of a relationship between voltage and time when the air battery of embodiment 2 charges/discharges;

FIG. 5 is a diagram of a relationship between voltage and time when the air battery of comparative embodiment 1 charges/discharges;

FIG. 6 is a diagram of a relationship between voltage and time when the air battery of comparative embodiment 2 charges/discharges;

FIG. 7 is a diagram of a relationship between voltage and time when the air battery of Comparative embodiment 3 charges/discharges;

FIG. 8 is a diagram of a relationship between voltage and time when the air battery of embodiment 3 charges/discharges; and

FIG. 9 is a diagram of a relationship between voltage and time when the air battery of comparative embodiment 4 charges/discharges.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

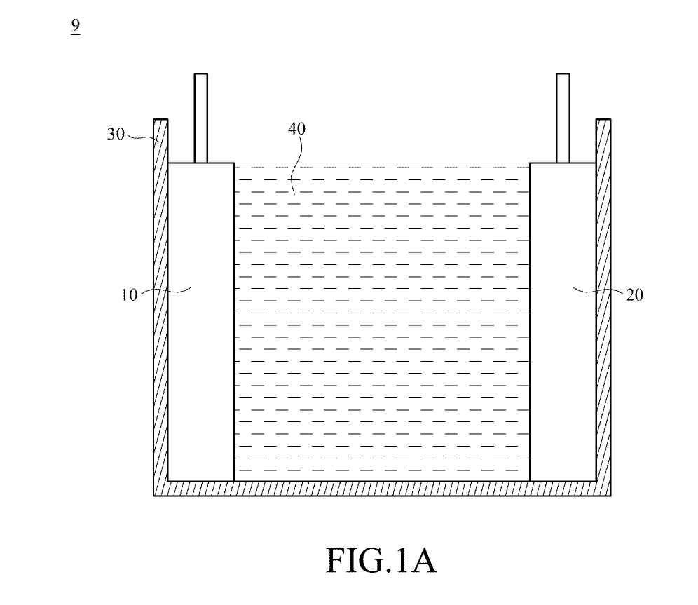

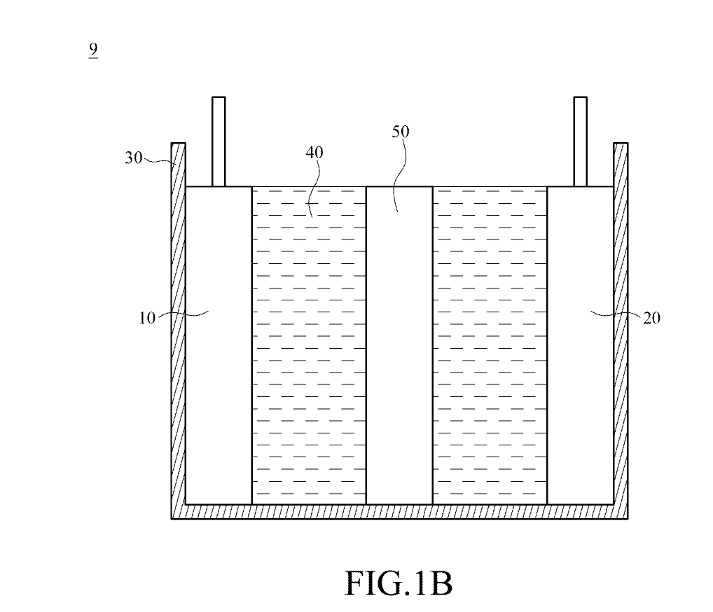

First, please refer to FIGS. 1A and 1B. FIG. 1A is a schematic cross-sectional view of an air battery according to an embodiment of the disclosure. FIG. 1B is a schematic cross-sectional view of an air battery according to another embodiment of the disclosure. In this and other embodiments, the air battery 9 is a secondary battery, which is rechargeable (that is, capable of charging and discharging repeatedly (i.e., reusable)). The air battery 9 comprises a metallic electrode 10, an air electrode 20, a battery box 30 and an electrolyte 40 (as shown in FIG. 1A). The metallic electrode 10, the air electrode 20 and the electrolyte 40 are disposed in the battery box 30. In some other embodiments, the air battery 9 further comprises a membrane 50 (as shown in FIG. 1B), but the disclosure is not limited thereto. The membrane 50 is disposed in the battery box 30 and the membrane 50 separates the air electrode 20 from the metallic electrode 10.

In this embodiment, the metallic electrode 10 is the anode of the air battery 9. Therefore, when the air battery 9 discharges, the metallic electrode 10 undergoes oxidation so that metals are oxidized into metallic ions. The metallic electrode 10 is made of, for example, copper, tin or zinc. In this embodiment, the air electrode 20 is the cathode of the air battery 9. Therefore, when the air battery 9 discharges, the air electrode 20 undergoes reduction so that oxygen is reduced. The structure and the composition of the air electrode 20 are described in the following paragraphs.

In this embodiment, the electrolyte 40 contains zinc ions. In some of the embodiments, which the metallic electrode 10 is made of copper or tin, the electrolyte 40 must contain zinc ions, and the air battery 9 needs to be charged first to deposit metallic zinc on the anode. As compared with the above embodiments, when the metallic electrode 10 is made of zinc, zinc ions are not necessary components in the electrolyte 40. Further, the air battery 9, which has a metallic electrode 10 made of zinc, is capable of performing both charging and discharging processes. In this embodiment, the electrolyte 40 is an alkaline solution containing zinc chloride or zinc oxide. The basic source of the alkaline solution is, for example, potassium hydroxide or sodium hydroxide.

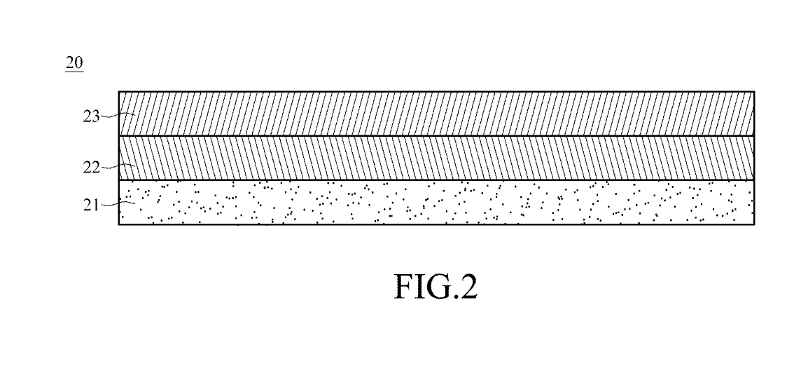

Please also refer to FIG. 2, which is a schematic cross-sectional view of an air electrode 20 according to an embodiment of the disclosure. In this and other embodiments, the air electrode 20 is used as the electrode of an air battery 9, which is capable of performing charging and discharging processes. The air electrode 20 comprises a current collector 21 and a catalytic layer 22. The composition of the current collector 21 contains nickel, chromium and iron. The catalytic layer 22 is loaded on the current collector 21. The material of the catalytic layer 22 contains α-MnO₂. In this embodiment, the air electrode 20 further comprises a hydrophobic layer 23. The hydrophobic layer 23 is disposed on the catalytic layer 22, so that the catalytic layer 22 is disposed between the current collector 21 and the hydrophobic layer 23.

Moreover, the weight percentage of nickel in the current collector 21 is between 8 wt % and 14 wt %, the weight percentage of chromium in the current collector 21 is between 16 wt % and 20 wt %, and the weight percentage of iron in the current collector 21 is greater than or equal to 60 wt %. The above mentioned-weight percentages are based on the total weight of the current collector 21.

In this and some other embodiments, the composition of the current collector 21 further contains carbon, manganese, molybdenum, silicon, phosphorus and sulfur. The weight percentage of carbon in the current collector 21 is 0.08 wt %, the weight percentage of manganese in the current collector 21 is 2 wt %, the weight percentage of molybdenum in the current collector 21 is between 2 wt % and 3 wt %, the weight percentage of silicon in the current collector 21 is 1 wt %, the weight percentage of phosphorus in the current collector 21 is 0.045 wt %, and the weight percentage of sulfur in the current collector 21 is 0.03 wt %. The above mentioned weight percentages are also based on the total weight of the current collector 21.

The current collector 21 is capable of both conducting electricity and catalyzing the reactions. Furthermore, since the composition of the current collector 21 contains nickel, chromium and iron, and the composition of nickel, chromium and iron have the above mentioned weight percentages, the current collector 21 is capable of conducting electricity and catalyzing oxygen evolution reaction (OER). In other words, the current collector 21 is also capable of catalyzing oxidization occurred at the positive electrode (anode) when the air battery 9 is charging.

The current collector 21 has a porous network. In this embodiment, the number of meshes of the current collector 21 is between 50 meshes and 350 meshes.

In this and some other embodiments, the thickness of the current collector 21 is 70 micrometers.

The catalytic layer 22 is adapted for catalyzing the reaction when the air battery 9 is charging. Moreover, since the composition of the catalytic layer 22 contains α-MnO₂, the catalytic layer 22 is capable of catalyzing oxygen reduction reaction (ORR) when the air battery 9 is discharging. Furthermore, the catalytic layer 22 is adapted for catalyzing reduction that occurs at the positive electrode (cathode) when the air battery is discharging.

In this and some other embodiments, the catalytic layer 22 further contains a carbon conductive material, for enhancing the conductivity of the catalytic layer 22. For example, the carbon conductive material is XC-72, acetylene carbon black, graphene, carbon nanotube, activated carbon or combinations thereof. The weight percentage of the carbon conductive material is between 10 wt % and 90 wt %, and the weight percentage of the carbon conductive material is based on the total weight of the catalytic layer 22.

In this and other embodiments, the catalytic layer 22 has a single catalyst, i.e. α-MnO₂. In some of the embodiments, the catalytic layer 22 is composed of α-MnO₂ and the carbon conductive material.

In this and some other embodiments, the catalytic layer 22 is loaded on the current collector 21 by coating. In some other embodiments, the catalytic layer 22 is adhered on the current collector 21 through an adhesive agent. For example, the adhesive agent is polyvinylidene fluoride (PVDF), but the disclosure is not limited thereto.

In this and some other embodiments, the hydrophobic layer 23 is capable of preventing water or moisture from infiltrating the hydrophobic layer 23 because of the hydrophobicity of the hydrophobic layer 23. Therefore, the hydrophobic layer 23 can prevent the water or moisture from infiltrating the air electrode 20 and harming the air electrode 20. Also, the hydrophobic layer 23 is capable of avoiding the electrolyte 40 leaking from the air battery 9. The hydrophobic layer 23 is, for example, a carbon cloth of Carbel CL®, but the disclosure is not limited thereto. Also, the hydrophobic layer 23 is porous, so that air (oxygen) is able to infiltrate the electrode 20, effusing to the catalytic layer 22 and the current collector 21 through the passages of the hydrophobic layer 23.

According to the above descriptions of the disclosure, the current collector 21 is capable of catalyzing oxidization occurred at the positive electrode (anode) when the air battery 9 is charging. Also, the catalytic layer 22 is capable of catalyzing reduction occurred at the positive electrode (cathode) when the air battery 9 is discharging. Therefore, the air battery 9 and the air electrode 20 thereof are bifunctional and are capable of charging and discharging repeatedly. The air battery 9 and the air electrode 20 are reusable, i.e., a secondary battery.

Moreover, the current collector 21 of the disclosure is capable of both conducting electricity and catalyzing oxygen evolution reaction. Therefore, the air electrode 10 only needs an ORR catalytic layer 22, and the air electrode 10 does not need other catalytic layers or other catalytic compositions (which are different from α-MnO₂). In this and other embodiments, the compositions for catalyzing oxygen evolution reaction and oxygen reduction reaction are disposed in different structures (that is, the current collector 21 and the catalytic layer 22), and are not mixed in a single structure. The air battery 9 and the air electrode 20 thereof have the above compositions and structural characteristic, so that the air battery 9 and the air electrode 20 have a higher discharging voltage and a lower charging voltage.

The followings describe the procedure for fabricating the catalytic layer according to an embodiment of the disclosure.

First, 5.143 g of XC72 and 4.056 g of manganese sulfate are mixed in a three-neck round-bottom flask. Then, 3.792 g of potassium permanganate and 60 mL of DI water are mixed in a beaker. Water is stirred by a magnet mixer until potassium permanganate is completely dissolved in water. The concentration of the potassium permanganate solution is about 0.4 M. Then, the potassium permanganate solution is poured into the three-neck round-bottom flask containing XC72 and manganese sulfate. Afterwards, the three-neck round-bottom flask is placed on a heating mixer. The temperature is 100° C. and the reaction time is 20 hours. After the reaction is complete, the solid in the solution is obtained by centrifugation. Then, the solid (powder) is placed in a furnace and dried under 120° C. for 24 hours. The dried solid (powder) is the catalytic layer (containing α-MnO₂ and carbon conductive material) of an embodiment of the disclosure.

The followings describe the air battery of the disclosure by multiple Embodiments and Comparative Embodiments, and the discharging/charging voltages are tested.

### Embodiment 1

Metallic anode: tin plate.

Current collector of the air electrode: carbon: 0.08 wt %, manganese: 2 wt %, chromium: 16-18 wt %, molybdenum: 2-3 wt %, nickel: 10-14 wt %, silicon: 1 wt %, phosphorus: 0.045 wt %, sulfur: 0.03 wt % and iron: the rest.

The catalytic layer of the air electrode: α-MnO₂ (58 wt %) and XC72 (25 wt %).

The hydrophobic layer of the air electrode: Carbel CL® (mean pore diameter: >10 μm; thickness: 325 μm-425 μm).

Electrolyte: sodium hydroxide (6M) and zinc hydroxide/zinc chloride (25 g/L).

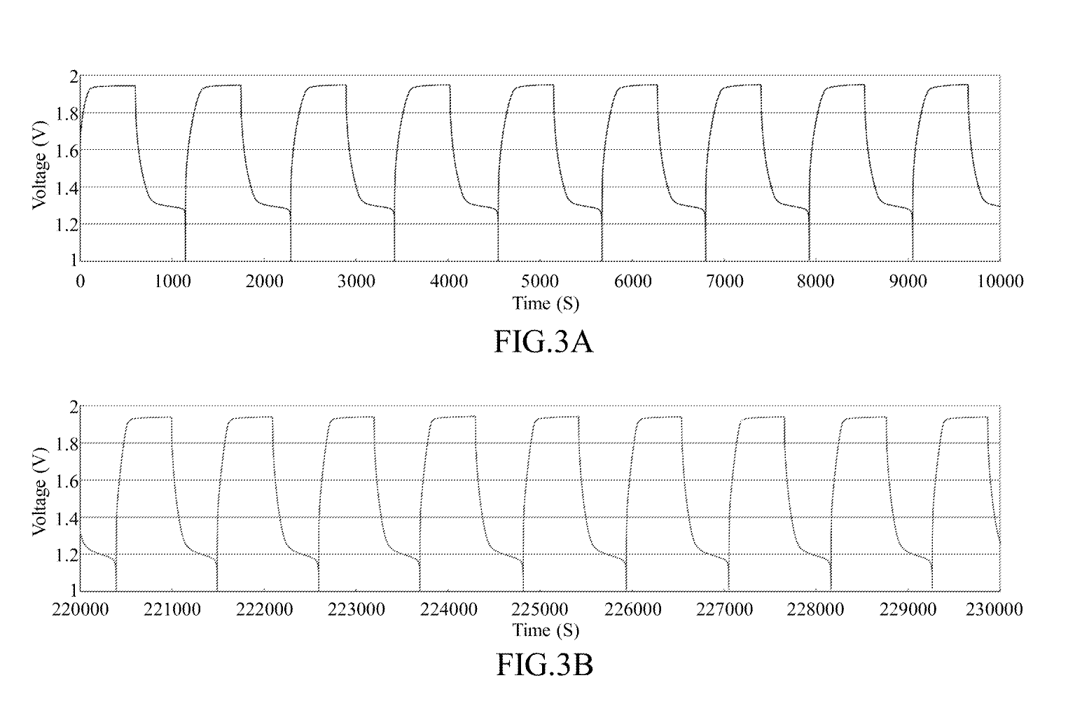

Then, the air battery is tested under a current density of 10 mA/cm². The air battery is charged for 10 minutes, and then the air battery is discharged. The result of the test is shown in FIGS. 3A-3B. FIG. 3A is a diagram of a relationship between voltage and time when the air battery of embodiment 1 charges/discharges. FIG. 3B is another diagram of a relationship between voltage and time when the air battery of embodiment 1 charges/discharges. As shown in the figures, the air battery of Embodiment 1 is capable of discharging for multiple cycles (more than 200 cycles). The air battery of Embodiment 1 has a voltage efficiency of 68% and a coulomb efficiency of 90%, the charging voltage of the air battery is about 1.9 voltages (V) and the discharging voltage is about 1.3 V during the first 10,000 seconds. The air battery of Embodiment 1 remains a voltage efficiency of 62% and a coulomb efficiency of 80% after 230,000-second operation.

### Embodiment 2

Metallic anode: tin plate.

Current collector of the air electrode: carbon: 0.08 wt %, manganese: 2 wt %, chromium: 16-18 wt %, molybdenum: 2-3 wt %, nickel: 10-14 wt %, silicon: 1 wt %, phosphorus: 0.045 wt %, sulfur: 0.03 wt % and iron: the rest.

The catalytic layer of the air electrode: α-MnO₂ (58 wt %) and acetylene carbon black (25 wt %).

The hydrophobic layer of the air electrode: Carbel CL® (mean pore diameter: >10 μm; thickness: 325 μm-425 μm).

Electrolyte: sodium hydroxide (6M) and zinc hydroxide/zinc chloride (25 g/L).

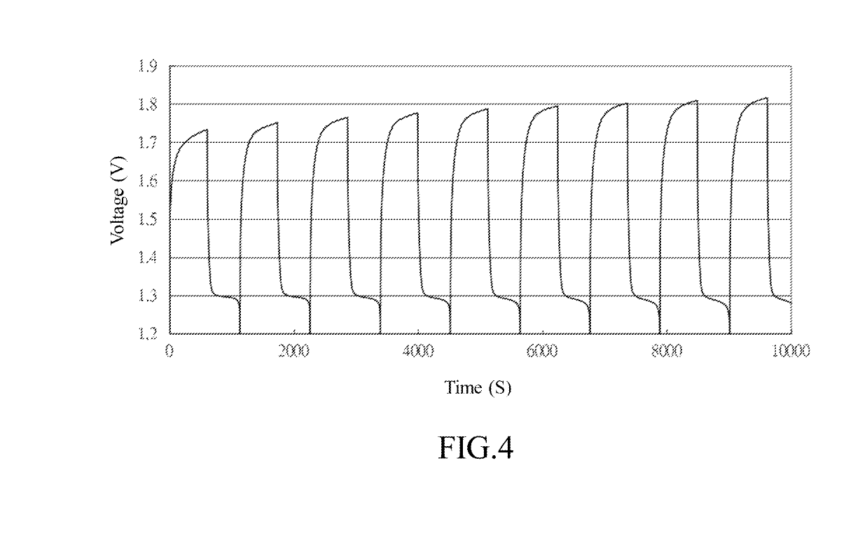

Then, the air battery is tested under a current density of 10 mA/cm². The air battery is charged for 10 minutes, and then the air battery is discharged. The result of the test is shown in FIG. 4, which is a diagram of a relationship between voltage and time when the air battery of embodiment 2 charges/discharges. As shown in the figure, the air battery of Embodiment 2 has a voltage efficiency of 75% when discharging begins, and the air battery of Embodiment 2 has a voltage efficiency of 72% in the first 10000 seconds. Also, the discharging voltage of the air battery of Embodiment 2 is about 1.75 V, and the charging voltage of the air battery of Embodiment 2 is about 1.3 V.

### Comparative Embodiment 1

Metallic anode: tin plate.

Current collector: carbon: 0.08 wt %, manganese: 2 wt %, chromium: 16-18 wt %, molybdenum: 2-3 wt %, nickel: 10-14 wt %, silicon: 1 wt %, phosphorus: 0.045 wt %, sulfur: 0.03 wt % and iron: the rest.

The hydrophobic layer of the air electrode: Carbel CL® (mean pore diameter: >10 μm; thickness: 325 μm-425 μm).

Electrolyte: sodium hydroxide (6M) and zinc hydroxide/zinc chloride (25 g/L).

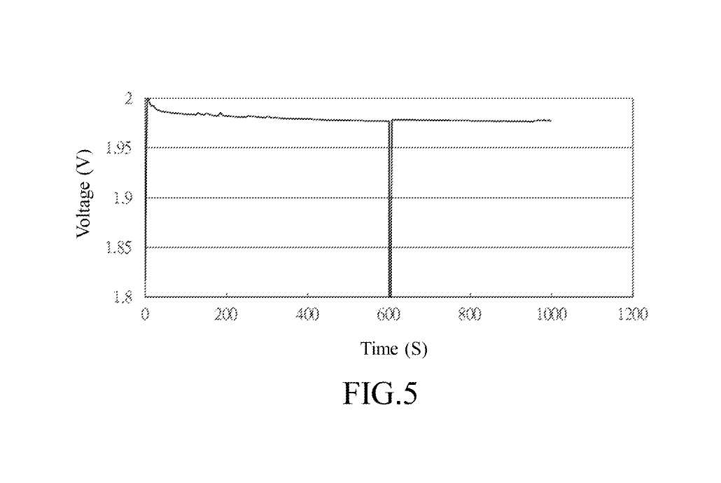

Then, the battery is tested under a current density of 10 mA/cm². The result of the test is shown in FIG. 5, which is a diagram of a relationship between voltage and time when the air battery of comparative embodiment 1 charges/discharges. As shown in the figure, the battery can only perform charging and cannot perform discharging. Also, the charging voltage of the battery of Comparative Embodiment 1 is near 2 V.

### Comparative Embodiment 2

Metallic anode: tin plate.

Current collector: carbon: 0.08 wt %, manganese: 2 wt %, chromium: 17.5-20 wt %, nickel: 8-11 wt %, silicon: 1 wt %, phosphorus: 0.045 wt %, sulfur: 0.03 wt % and iron: the rest.

The hydrophobic layer of the air electrode: Carbel CL® (mean pore diameter: >10 μm; thickness: 325 μm-425 μm).

Electrolyte: sodium hydroxide (6M) and zinc hydroxide/zinc chloride (25 g/L).

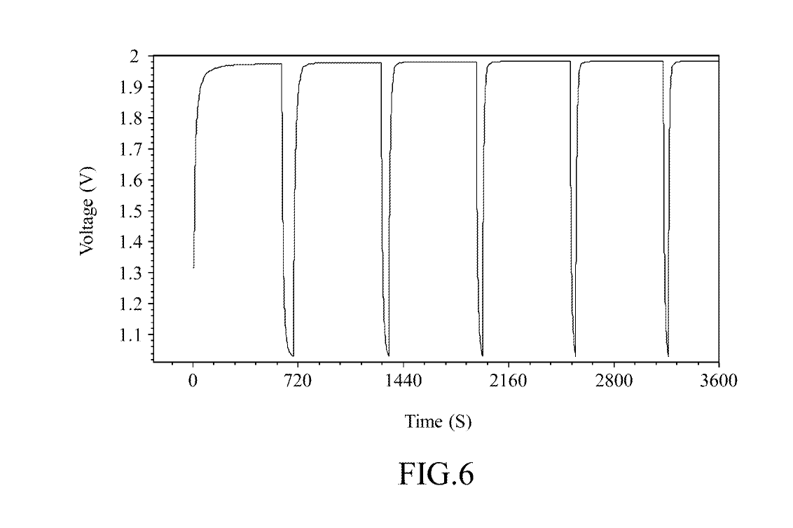

Then, the battery is tested under a current density of 10 mA/cm². The result of the test is shown in FIG. 6, which is a diagram of a relationship between voltage and time when the air battery of comparative embodiment 2 charges/discharges. As shown in the figure, the battery can only perform charging and cannot perform discharging. Also, the charging voltage of the battery of Comparative Embodiment 2 is near 2 V.

### Comparative Embodiment 3

Metallic anode: tin plate.

Current collector of the air electrode: nickel foam.

The catalytic layer of the air electrode: none.

The hydrophobic layer of the air electrode: Carbel CL® (mean pore diameter: >10 μm; thickness: 325 μm-425 μm).

Electrolyte: sodium hydroxide (6M) and zinc hydroxide/zinc chloride (25 g/L).

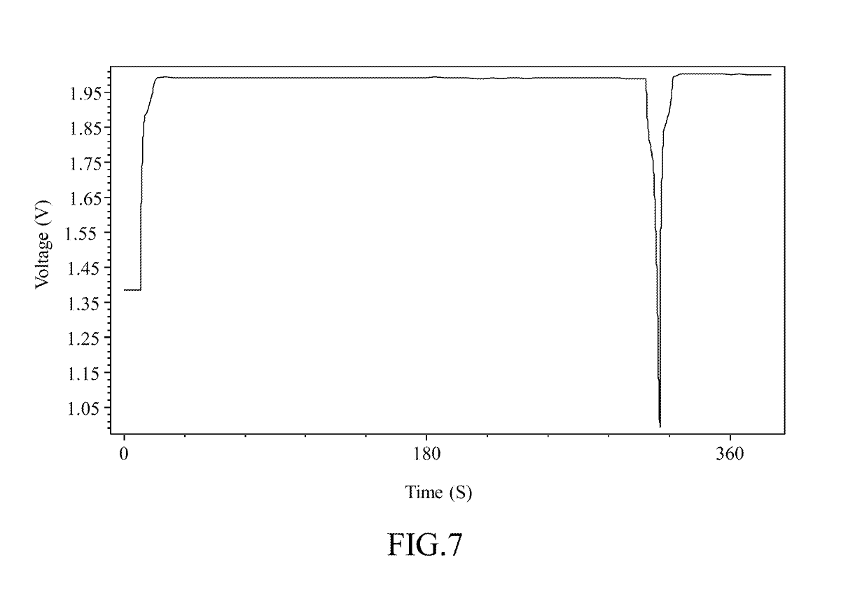

Then, the battery is tested under a current density of 10 mA/cm². The result of the test is shown in FIG. 7, which is a diagram of a relationship between voltage and time when the air battery of Comparative embodiment 3 charges/discharges. As shown in the figure, the battery can only perform charging and cannot perform discharging. Also, the charging voltage of battery of Comparative Embodiment 3 is about 1.95 V.

According to the above comparisons, the differences between Embodiments 1-2 and Comparative Embodiments 1-3 are that: a catalytic layer containing α-MnO₂ is disposed in the air batteries of Embodiments 1-2, while Comparative Embodiments 1-3 do not have the catalytic layer containing α-MnO₂, and the current collector of Comparative Embodiment 3 is nickel foam. In Comparative Embodiments 1-3, since the catalytic layer does not contain α-MnO₂, Comparative Embodiments 1-3 cannot perform discharging and have a higher charging voltage.

### Embodiment 3

Metallic anode: tin plate.

Current collector of the air electrode: carbon: 0.08 wt %, manganese: 2 wt %, chromium: 16-18 wt %, molybdenum: 2-3 wt %, nickel: 10-14 wt %, silicon: 1 wt %, phosphorus: 0.045 wt %, sulfur: 0.03 wt % and iron: the rest.

The catalytic layer of the air electrode: α-MnO₂ (20 wt %) and activated carbon (60 wt %).

The hydrophobic layer of the air electrode: Carbel CL® (mean pore diameter: >10 μm; thickness: 325 μm-425 μm).

Electrolyte: sodium hydroxide (6M) and zinc hydroxide/zinc chloride (25 g/L).

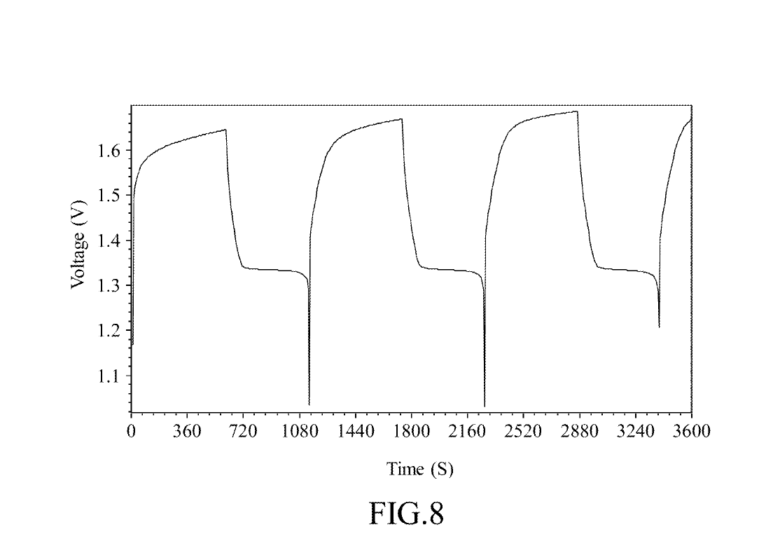

Then, the air battery is tested under a current density of 10 mA/cm². The air battery is charged for 10 minutes, and then the air battery is discharged. The result of the test is shown in FIG. 8, which is a diagram of a relationship between voltage and time when the air battery of embodiment 3 charges/discharges. As shown in the figure, the discharging voltage of the air battery of Embodiment 3 is about 1.66 V, and the charging voltage of the air battery of Embodiment 3 is about 1.33 V.

### Comparative Embodiment 4

Metallic anode: zinc plate.

Current collector of the air electrode: carbon: nickel foam.

The catalytic layer of the air electrode: perovskite (LaCoO₃) (50 wt %) and XC72 (25 wt %).

The hydrophobic layer of the air electrode: Carbel CL® (mean pore diameter: >10 μm; thickness: 325 μm-425 μm).

Electrolyte: sodium hydroxide (6M).

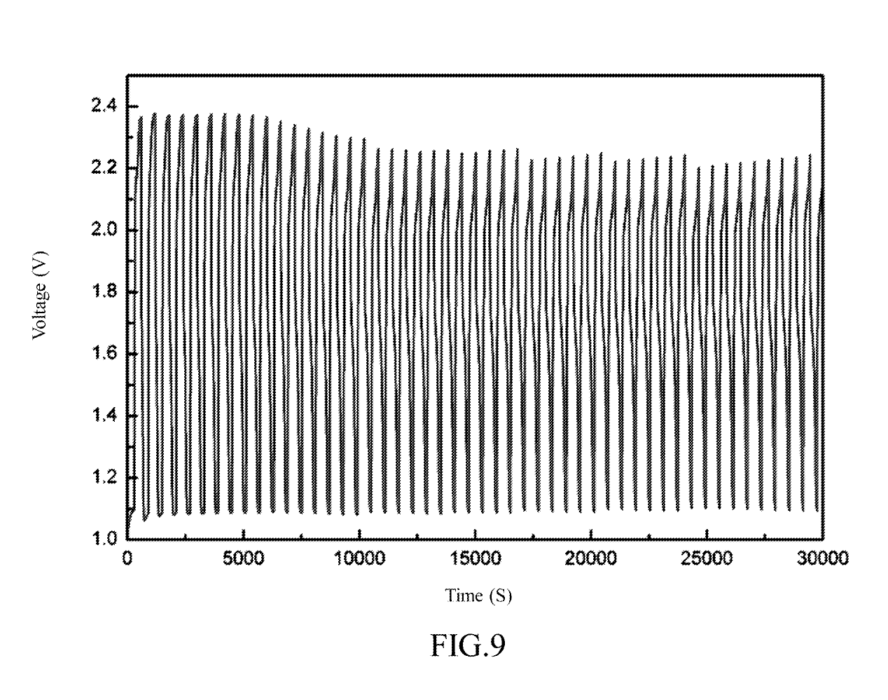

Then, the air battery is tested under a current density of 25 mA/cm². The result of the test is shown in FIG. 9, which is a diagram of a relationship between voltage and time when the air battery of comparative embodiment 4 charges/discharges. As shown in the figure, the discharging voltage of the air battery of Comparative Embodiment 4 is 2.2-2.4 V, and the charging voltage of the air battery of Comparative Embodiment 4 is about 1.1 V.

According to the above comparisons, the differences between Embodiment 3 and Comparative Embodiment 4 are that: the catalyst of Embodiment 3 is α-MnO₂, while the catalyst of Comparative Embodiment 4 is perovskite. According to the above differences, the air battery of Embodiment 3 has a higher discharging voltage and a lower charging voltage, as compared to Comparative Embodiment 4.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An air electrode, comprising:
a current collector, the composition of the current collector containing nickel, chromium and iron; and
a catalytic layer, loaded on the current collector, the material of the catalytic layer containing α-MnO₂.

2. The air electrode according to claim 1, wherein the weight percentage of nickel in the current collector is between 8 wt % and 14 wt %, the weight percentage of chromium in the current collector is between 16 wt % and 20 wt %, the weight percentage of iron in the current collector is greater than or equal to 60 wt %, and wherein the weight percentage of nickel, the weight percentage of chromium and the weight percentage of iron are based on the total weight of the current collector.

3. The air electrode according to claim 2, wherein the composition of the current collector further comprises carbon, manganese, molybdenum, silicon, phosphorus and sulfur, the weight percentage of carbon in the current collector is 0.08 wt %, the weight percentage of manganese in the current collector is 2 wt %, the weight percentage of molybdenum in the current collector is between 2 wt % and 3 wt %, the weight percentage of silicon in the current collector is 1 wt %, the weight percentage of phosphorus in the current collector is 0.045 wt %, the weight percentage of sulfur in the current collector is 0.03 wt %, and wherein the weight percentage of carbon, the weight percentage of manganese, the weight percentage of molybdenum, the weight percentage of silicon, the weight percentage of phosphorus and the weight percentage of sulfur are based on the total weight of the current collector.

4. The air electrode according to claim 1, further comprising a hydrophobic layer, disposed on the catalytic layer, wherein the catalytic layer is disposed between the current collector and the hydrophobic layer.

5. The air electrode according to claim 1, wherein the material of the catalytic layer further comprises a carbon conductive material.

6. The air electrode according to claim 5, wherein the material of the catalytic layer is composed of α-MnO₂ and the carbon conductive material.

7. The air electrode according to claim 5, wherein the carbon conductive material is XC-72, acetylene carbon black, graphene, carbon nanotube, activated carbon or combinations thereof.

8. The air electrode according to claim 5, wherein the weight percentage of the carbon conductive material is between 10 wt % and 90 wt %, and the weight percentage of the carbon conductive material is based on the total weight of the catalytic layer.

9. The air electrode according to claim 1, wherein the catalytic layer is loaded on the current collector through an adhesive agent.

10. The air electrode according to claim 1, wherein the number of meshes of the current collector is between 50 meshes and 350 meshes.

11. The air electrode according to claim 1, wherein the thickness of the current collector is 70 micrometers.

12. An air battery, comprising:
a metallic electrode;
an air electrode, comprising:
a current collector, and the composition of the current collector containing nickel, chromium and iron; and
a catalytic layer, loaded on the current collector, and the material of the catalytic layer containing α-MnO₂;
a battery box, wherein the metallic electrode and the air electrode are disposed in the battery box; and
an electrolyte, disposed in the battery box.

13. The air battery according to claim 12, further comprising a membrane, disposed in the battery box, wherein the membrane separates the air electrode from the metallic electrode.

14. The air battery according to claim 12, wherein the material of the metallic electrode is copper, tin or zinc.

15. The air battery according to claim 12, wherein the electrolyte comprises zinc ions.

16. The air battery according to claim 12, wherein the weight percentage of nickel in the current collector is between 8 wt % and 14 wt %, the weight percentage of chromium in the current collector is between 16 wt % and 20 wt %, the weight percentage of iron in the current collector is greater than or equal to 60 wt %, the weight percentage of nickel, and wherein the weight percentage of chromium and the weight percentage of iron are based on the total weight of the current collector.

17. The air battery according to claim 12, wherein the composition of the current collector further comprises carbon, manganese, molybdenum, silicon, phosphorus and sulfur, the weight percentage of carbon in the current collector is 0.08 wt %, the weight percentage of manganese in the current collector is 2 wt %, the weight percentage of molybdenum in the current collector is between 2 wt % and 3 wt %, the weight percentage of silicon in the current collector is 1 wt %, the weight percentage of phosphorus in the current collector is 0.045 wt %, the weight percentage of sulfur in the current collector is 0.03 wt %, and wherein the weight percentage of carbon, the weight percentage of manganese, the weight percentage of molybdenum, the weight percentage of silicon, the weight percentage of phosphorus and the weight percentage of sulfur are based on the total weight of the current collector.

18. The air battery according to claim 12, further comprising a hydrophobic layer, disposed on the catalytic layer, wherein the catalytic layer disposed between the current collector and the hydrophobic layer.

19. The air battery according to claim 12, wherein the material of the catalytic layer further comprises a carbon conductive material.

20. The air battery according to claim 19, wherein the material of the catalytic layer is composed of α-MnO₂ and the carbon conductive material.

21. The air battery according to claim 19, wherein the carbon conductive material is XC-72, acetylene carbon black, grapheme, carbon nanotube, activated carbon or combinations thereof.

22. The air battery according to claim 19, wherein weight percentage of the carbon conductive material is between 10 wt % and 90 wt %, and the weight percentage of the carbon conductive material is based on the total weight of the catalytic layer.

23. The air battery according to claim 12, wherein the catalytic layer is loaded on the current collector through an adhesive agent.

24. The air battery according to claim 12, wherein the number of meshes of the current collector is between 50 meshes and 350 meshes.

25. The air battery according to claim 12, wherein the thickness of the current collector is 70 micrometers.
